(19) United States
(12) Patent Application Publication
(10) Pub. No.: US 2015/0061539 A1
(43) Pub. Date: Mar. 5, 2015

(54) ELECTRONIC DEVICE, COMPUTER PROGRAM PRODUCT, AND CONTROL SYSTEM

(71) Applicant: Kabushiki Kaisha Toshiba, Tokyo (JP)

(72) Inventors: Noriyuki HIRAYAMA, Fuchu-shi (JP); Satoshi ODAKURA, Kodaira-shi (JP); Hiroko ISHIKAWA, Tokyo (JP); Mayuko YOSHIDA, Tokyo (JP); Toshiaki TAKAMA, Ageo-shi (JP)

(73) Assignee: Kabushiki Kaisha Toshiba, Tokyo (JP)

(21) Appl. No.: 14/262,526

(22) Filed: Apr. 25, 2014

(30) Foreign Application Priority Data
Aug. 27, 2013 (JP) 2013-176054

(51) Int. Cl. H05B 37/02

(52) U.S. Cl. CPC H05B 37/0272
USPC 315/292

(57) ABSTRACT

According to one embodiment, an electronic device includes an input display controller, a converter, a transmitter. The input display controller displays a setting area for setting one or more control parameters with respect to lighting control of a lighting device on a display and to accept a touch operation on the setting area. The converter converts position coordinates of the touch operation on the setting area into the one or more control parameters corresponding to the position coordinates. The transmitter transmits a control command indicative of the one or more control parameters to the lighting device and to transmit, when the touch operation is continuously performed for a first duration, a first control command indicative of one or more first control parameters corresponding to the position coordinates of the touch operation continuously performed for the first duration to the lighting device at a first transmission interval.

### CROSS-REFERENCE TO RELATED APPLICATIONS

This application is based upon and claims the benefit of priority from Japanese Patent Application No. 2013-176054, filed on Aug. 27, 2013, the entire contents of which are incorporated herein by reference.

### FIELD

An embodiment described herein relates generally to an electronic device, a computer program product, and a control system.

### BACKGROUND

In recent years, a lighting device incorporating a dimming function, a color toning function, or the like has been widely used. In such a lighting device, a desired color tone, brightness, or the like can be adjusted by using a remote controller utilizing infrared rays.

In such a conventional technique, it has been desired that an intended adjustment is performed with respect to the lighting device in a short time.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating one example of a network configuration of a lighting control system and a hardware configuration of an electronic device according to an embodiment;

FIG. 2 is an exemplary block diagram illustrating one example of a functional configuration of the electronic device in the present embodiment;

FIG. 3 is an exemplary view illustrating one example of a two-dimensional control parameter setting window in the present embodiment;

FIG. 4 is an exemplary view illustrating another example of the two-dimensional control parameter setting window in the present embodiment;

FIG. 5 is an exemplary view illustrating one example of a scene selection window in the present embodiment;

FIG. 6 is an exemplary block diagram illustrating one example of a functional configuration of the lighting apparatus in the present embodiment;

FIG. 7 is an exemplary flowchart illustrating procedures of lighting control processing in the present embodiment;

FIG. 8 is an exemplary view illustrating a two-dimensional control parameter setting window of a modification in the present embodiment; and

FIG. 9 is an exemplary view illustrating another example of the two-dimensional control parameter setting window of the modification in the present embodiment.

### DETAILED DESCRIPTION

In general, according to one embodiment, an electronic device comprises an input display controller, a converter, a transmitter. The input display controller is configured to display a setting area for setting one or more control parameters with respect to lighting control of a lighting device on a display and to accept a touch operation on the setting area. The converter is configured to convert position coordinates of the touch operation on the setting area into the one or more control parameters corresponding to the position coordinates. The transmitter is configured to transmit a control command indicative of the one or more control parameters to the lighting device and to transmit, when the touch operation is continuously performed for a first duration, a first control command indicative of one or more first control parameters corresponding to the position coordinates of the touch operation continuously performed for the first duration to the lighting device at a first transmission interval.

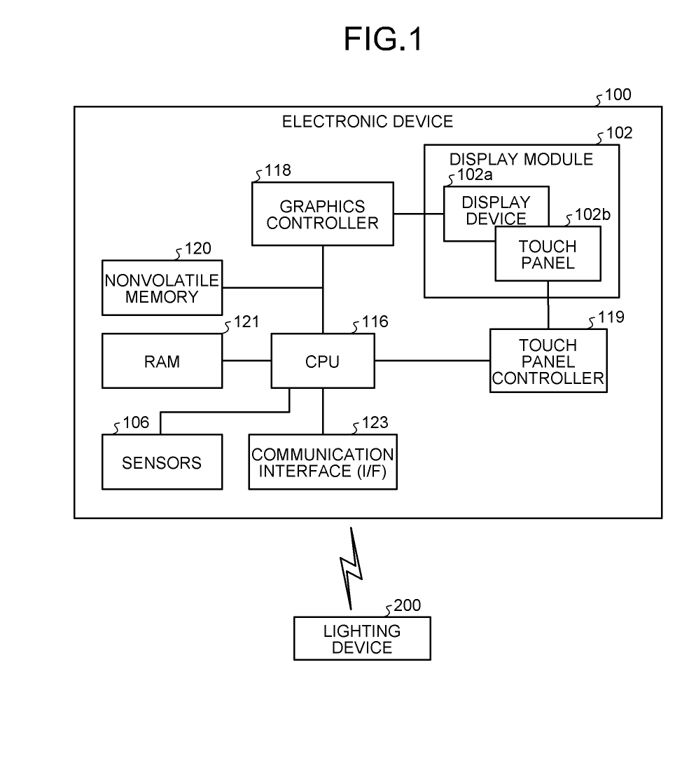

A lighting control system in the present embodiment has, as illustrated in FIG. 1, a configuration in which an electronic device 100 and a lighting device 200 are connected to a network such as the Internet.

The lighting device 200 is a lighting device using a light emitting diode (LED). In the present embodiment, a red LED, a green LED, and a blue LED are used. The lighting device 200 is capable of adjusting a color tone, brightness, or the like by the control from the electronic device 100.

The electronic device 100 is a handheld terminal that functions as a remote controller for performing lighting control with respect to the lighting device 200. The electronic device 100 is, for example, provided as a mobile phone such as a smart phone provided with a touch panel, a tablet terminal, a slate-type terminal, or the like. The electronic device 100 executes a predetermined lighting control application program to perform lighting control with respect to the lighting device 200. Here, a communication between the electronic device 100 and the lighting device 200 is performed in conformity to the ECHONET Lite Specification.

As illustrated in FIG. 1, the electronic device 100 is provided with a display module 102, a central processing unit (CPU) 116, a graphics controller 118, a touch panel controller 119, a nonvolatile memory 120, a random access memory (RAM) 121, a communication interface (I/F) 123, sensors 106, and the like. In addition to the above-mentioned components, the electronic device 100 may be provided with a camera, a microphone, a speaker, or the like.

The display module 102 is constituted of a combination of a display device 102a and a touch panel 102b that functions as a touch screen. The display device 102a is, for example, a liquid crystal display (LCD), an organic electro luminescent (EL) display, or the like. The touch panel 102b detects a position (a touch position) of a finger of a user or a stylus pen that touches the display screen of the display device 102a.

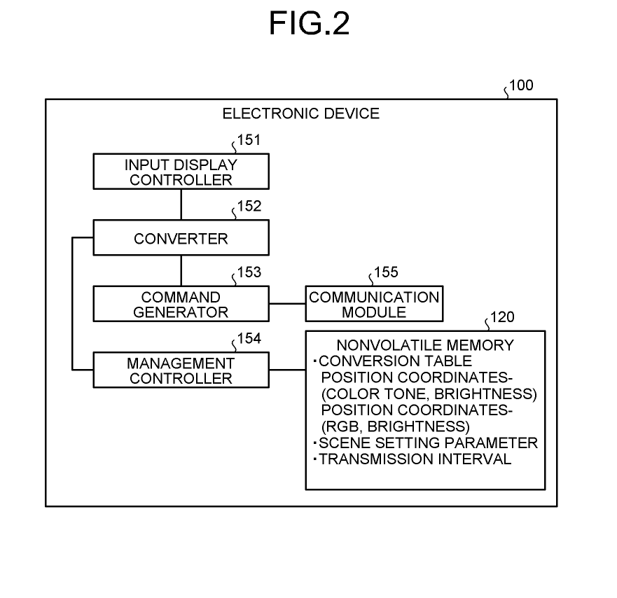

The nonvolatile memory 120 stores therein various kinds of data or the like required for executing an operating system or various kinds of application programs. The CPU 116 is a processor that controls operations of the electronic device 100 and controls each component of the electronic device 100. The CPU 116 executes various kinds of application programs comprising the operating system or lighting control application programs that are loaded from the nonvolatile memory 120 into the RAM 121 thus providing each functional module (see FIG. 2) described later. The RAM 121 functions as a main memory to provide a work area when the CPU 116 executes computer programs.

The graphics controller 118 is a display controller that controls the display device 102a of the display module 102. The touch panel controller 119 controls the touch panel 102b to acquire coordinate data indicating the touch position by a user from the touch panel 102b.

The communication I/F 123 is controlled by the CPU 116 and executes a wireless communication with the lighting device 200 or a communication by a network such as the Internet. Each of the sensors 106 is an acceleration sensor, an azimuth sensor, a gyro sensor, or the like.

The electronic device 100 provides each module illustrated in FIG. 2 by the collaboration between the CPU 116 and computer programs (the operating system, various kinds of application programs such as the lighting control application program) stored in the nonvolatile memory 120.

The electronic device 100 in the present embodiment is, as the functional configuration illustrated in FIG. 2, mainly provided with an input display controller 151, a converter 152, a command generator 153, a management controller 154, and a communication module 155. Here, in FIG. 2, the above-mentioned nonvolatile memory 120 is also illustrated.

The nonvolatile memory 120 stores therein a conversion table, a scene setting parameter, and a transmission interval as the above-mentioned various kinds of data. The conversion table comprises table data such that position coordinates of the touch position on the touch panel 102b correspond to a two-dimensional control parameter with respect to lighting control. Here, the two-dimensional control parameter means, when each of the position coordinates is expressed as an x-axis coordinate and a y-axis coordinate, a parameter having at least two parameters (a control parameter 1, a control parameter 2) corresponding to coordinates (x, y). The two-dimensional control parameter is one example of one or a plurality of control parameters.

The present embodiment uses (color tone parameter, brightness parameter) and (RGB parameter, brightness parameter) as the two-dimensional control parameter. The color tone parameter is a control parameter for controlling a color tone of the lighting device 200 and indicates the ratio of an incandescent bulb color, a neutral white color, and a daylight color. The brightness parameter is a control parameter for controlling brightness of the lighting device 200. The RGB parameter is a control parameter for controlling an RGB balance of the lighting device 200. The lighting device 200 changes the color tone, the brightness, or the RGB balance depending on each value of these control parameters.

Accordingly, as the conversion table, there are two conversion tables; that is, a position coordinates-(color tone parameter, brightness parameter) conversion table, and a position coordinates-(RGB parameter, brightness parameter) conversion table. In the position coordinates-(color tone parameter, brightness parameter) conversion table, a value of (color tone parameter, brightness parameter) is specified corresponding to position coordinates (x, y), and an x coordinate and a y coordinate correspond to a value of the color tone parameter and a value of the brightness parameter respectively. Furthermore, in the position coordinates-(RGB parameter, brightness parameter) conversion table, a value of (RGB parameter, brightness parameter) is specified corresponding to position coordinates (x, y), and an x coordinate and a y coordinate correspond to a value of the RGB parameter and a value of the brightness parameter respectively.

The scene setting parameter is data in which a control parameter adjusted corresponding to each scene in advance or a control parameter set as a favorite by a user is registered for each scene with a scene name assigned. The transmission interval is an interval of a time at which a control command is transmitted when a touch operation is continuously performed.

The input display controller 151 displays a setting window of the two-dimensional control parameter on the display device 102a via the graphics controller 118. In the setting window of the two-dimensional control parameter, a setting area of the two-dimensional control parameter is displayed.

Here, the setting area of the two-dimensional control parameter is an area in which a state of adjustment corresponding to the two-dimensional control parameter is visually displayed and, at the same time, the two-dimensional control parameter is specified by the touch operation. In the setting area, a touch position corresponds to a value of the two-dimensional control parameter.

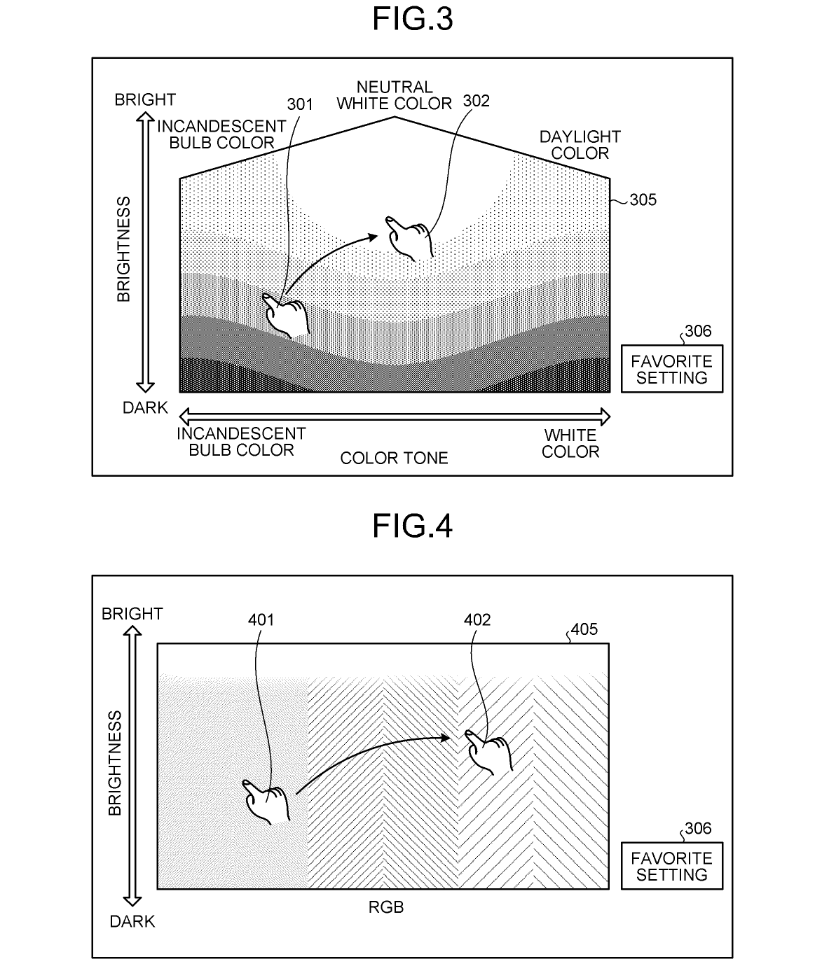

FIG. 3 is a view illustrating one example of the two-dimensional control parameter setting window in the present embodiment. In FIG. 3, the two-dimensional control parameter setting window is displayed on the full screen of the display device 102a. In FIG. 3, when the two-dimensional control parameter is (color tone parameter, brightness parameter), a setting area is displayed in the two-dimensional control parameter setting window. In FIG. 3, a portion formed in a house-like shape is a setting area 305 for adjusting a color tone and brightness of the lighting device 200.

In FIG. 3, an origin is set at the lower left point of the setting area 305. In FIG. 3, an axis of abscissas indicates an x axis in the position coordinates and indicates the range of the value of the color tone parameter. In FIG. 3, an axis of ordinate indicates a y axis in the position coordinates and indicates the range of the value of the brightness parameter. In the above-mentioned position coordinates-(color tone parameter, brightness parameter) conversion table, the color tone parameter indicating the ratio of the incandescent bulb color, the neutral white color, and the daylight color, and the brightness parameter are mapped on the position coordinates in the setting area 305 in FIG. 3.

In addition, in FIG. 3, corresponding to the color tone parameter on the x axis and the brightness parameter on the y axis, a state of a color tone and brightness is visually indicated depending on the two control parameters. Here, in FIG. 3, although the setting area is divided into several hatched portions to indicate a state of the color tone and the brightness depending on the two control parameter, a state of the color tone and the brightness depending on the two control parameter is gradationally plotted on an actual screen.

The input display controller 151 displays, as illustrated in FIG. 3, the setting area 305 of (color tone parameter, brightness parameter) on the display device 102a. A user touches an intended position in the setting area 305 on the display device 102a; that is, in the setting area 305 on the touch panel 102b, to specify (color tone parameter, brightness parameter).

FIG. 4 is a view illustrating another example of the two-dimensional control parameter setting window in the present embodiment. In FIG. 4, the two-dimensional control parameter setting window is displayed on the full screen of the display device 102a. In FIG. 4, when the two-dimensional control parameter is (RGB parameter, brightness parameter), a setting area is displayed in the two-dimensional control parameter setting window. In FIG. 4, a color palette area is used as a setting area 405 for adjusting the RGB balance of the lighting device 200.

In FIG. 4 also, an origin is set at the lower left point of the setting area 405. In FIG. 4, an axis of abscissas indicates an x axis in position coordinates and indicates the range of the value of the RGB parameter. In FIG. 4, an axis of ordinate indicates a y axis in the position coordinates and indicates the range of the value of the brightness parameter. In the above-mentioned position coordinates-(RGB parameter, brightness parameter) conversion table, the RGB parameter and the brightness parameter are mapped on the position coordinates in the setting area 405 in FIG. 4.

In FIG. 4, corresponding to the RGB parameter on the x axis and the brightness parameter on the y axis, a state of an RGB balance and brightness is visually indicated depending on the two control parameters. Here, in FIG. 4, although the setting area is divided into several hatched portions to indicate a state of the RGB balance and the brightness depending on the two control parameter, a state of the RGB balance and the brightness depending on the two control parameter is gradationally plotted on an actual screen.

The input display controller 151 displays, as illustrated in FIG. 4, the setting area 405 of (RGB parameter, brightness parameter) on the display device 102a. A user touches an intended position in the setting area 405 on the display device 102a; that is, in the setting area 405 on the touch panel 102b, to specify (RGB parameter, brightness parameter).

The input display controller 151 accepts the touch operation of the user on the touch panel 102b of the display module 102 via the touch panel controller 119. In this process, the input display controller 151 acquires position coordinates of a touch position on the touch panel 102b from the touch panel controller 119.

Here, there exists the case that a user continuously performs the touch operation with respect to the touch panel 102b. To be more specific, an operation such that the user touches and drags on the touch panel 102b with a finger, a stylus pen, or the like; that is, an operation such that the user moves the finger, the stylus pen, or the like while maintaining a state of touching the touch panel 102b is conceivable.

For example, as illustrated in FIG. 3, an operation such that a user touches with a finger in the setting area 305 of (color tone parameter, brightness parameter) at a position indicated by a symbol 301 and drags with the finger from the position indicated by the symbol 301 to a position indicated by a symbol 302 is conceivable. That is, the user starts to touch with a finger on the touch panel 102b at the position indicated by the symbol 301, moves the finger to the position indicated by the symbol 302 while touching with the finger, and releases the finger from the touch panel 102b whereby the touch operation finishes.

In FIG. 4 also, an operation such that a user touches with a finger in the setting area 405 of (RGB parameter, brightness parameter) at a position indicated by a symbol 401 and moves with the finger from the position indicated by the symbol 401 to a position indicated by a symbol 402 is illustrated.

When such a continuous touch operation is detected, the input display controller 151 periodically acquires the position coordinates of a touch position being in motion from the touch panel controller 119.

The converter 152 converts a position coordinates of a touch operation on the touch panel 102b into a two-dimensional control parameter corresponding to the position coordinates in the conversion table. That is, when a user performs a touch operation in the setting area 305 illustrated in FIG. 3, the converter 152 converts the position coordinates of the touch operation into the color tone parameter and the brightness parameter that are mapped in the position coordinates-(color tone parameter, brightness parameter) conversion table. Furthermore, when the user performs a touch operation in the setting area 405 illustrated in FIG. 4, the converter 152 converts the position coordinates of the touch operation into the RGB parameter and the brightness parameter that are mapped in the position coordinates-(RGB parameter, brightness parameter) conversion table.

Furthermore, when a touch operation is continuously performed, the converter 152 successively converts the position coordinates of the touch position acquired periodically into the two-dimensional parameter in reference to the above-mentioned conversion table. Accordingly, when a user quickly moves (drags with) a finger, a stylus pen, or the like, while continuously performing a touch operation, the speed of changing the two-dimensional control parameter corresponding to the position coordinates of the touch position is increased. On the other hand, when the user slowly moves (drags with) the finger, the stylus pen, or the like, while continuously performing the touch operation, the speed of changing the two-dimensional control parameter corresponding to the position coordinates of the touch position is reduced. Therefore, compared with a conventional technique such that the difference of changing the control parameter is always constant, the time until the display screen of the display device 102a reaches the desired color tone, brightness, and RGB balance can be reduced.

The converter 152 determines, at a time when the continuous touch operation finishes; that is, at a time when the user releases the finger, the stylus pen, or the like from the touch panel 102b, the two-dimensional control parameter converted from the position coordinates of the touch operation at the time when the continuous touch operation finishes.

The command generator 153 generates a control command that specifies a two-dimensional control parameter obtained in the converter 152. The control command is compliant with the ECHONET Lite Specification.

The communication module 155 transmits the control command comprising the two-dimensional control parameter generated by the command generator 153 to the lighting device 200 via the communication I/F 123. The communication module 155 reads out, when a touch operation is continuously performed, a transmission interval from the nonvolatile memory 120 and transmits the two-dimensional control parameter converted from the position coordinates of the touch operation continuously performed to the lighting device 200 for every transmission interval. Here, a fade parameter is received in advance from the lighting device 200, and the transmission interval is determined based on the fade parameter.

Here, the fade parameter indicates a time required for changing the control parameters (the color tone parameter, the brightness parameter, and the RGB parameter) of the lighting device 200 by one step. When the fade parameter becomes larger, the lighting device 200 changes a color tone, brightness, and an RGB value in a longer time and hence, the transmission interval is set to a longer time. By contrast, when the fade parameter becomes smaller, the lighting device 200 changes the color tone, the brightness, and the RGB value in a shorter time and hence, the transmission interval is set to a shorter time. In this manner, the transmission interval is determined corresponding to a time of one-step change of the color tone, the brightness, and the RGB value thus showing the lighting device 200 to a user in such a manner that the color tone, the brightness, and the RGB value of lights emitted from the lighting device 200 are continuously changed.

Here, in the present embodiment, the transmission interval is set based on the fade parameter of the lighting device 200; however, the present embodiment is not limited to this example. For example, the transmission interval can be determined corresponding to the other characteristics of the lighting device 200 or can be arbitrarily determined.

Furthermore, in the present embodiment, the communication module 155 may not necessarily comprise two control parameters that indicate a two-dimensional control parameter in a control command, and may be configured to transmit a control command comprising only one control parameter. For example, in such a case that a touch operation that moves in the horizontal direction in the setting area 405 in FIG. 4 is performed, the brightness parameter is not changed and hence, a control command comprising the RGB parameter only out of the brightness parameter and the RGB parameter may be transmitted. In the same manner as above, in the case where a touch operation that moves in the vertical direction in the setting area 405 is accepted, a control command comprising the brightness parameter only may be transmitted. Furthermore, not only in the case where the touch operation that drags in the horizontal direction or in the vertical direction is performed but also in the case where one of parameters in the two-dimensional control parameter corresponding to coordinates when the touch operation is accepted is identical with a parameter currently set in the lighting device 200, the communication module 155 may transmit a control command comprising the other parameter only.

The management controller 154 stores a control parameter (comprising a control parameter determined at the time when a continuous touch operation finishes) set by a touch operation in the nonvolatile memory by the instruction of a user, and performs such a management of the control parameter that the control parameter stored is invoked.

To be more specific, when the user sets the control parameter in the setting area 305 or 405 in FIG. 3 or FIG. 4 (the touch operation finishes) and touches thereafter a favorite setting button 306 provided to the lower right side of the setting area 305 or 405, the input display controller 151 detects an event of touching the favorite setting button 306 via the touch panel controller 119.

Furthermore, when the event of touching the favorite setting button 306 is detected, the management controller 154 stores the two-dimensional control parameter determined in the converter 152 as a favorite in the scene setting parameter in the nonvolatile memory 120. When there exist a plurality of two-dimensional control parameters set as favorites, the management controller 154 sets each two-dimensional control parameter with a number such as “favorite 1” or “favorite 2”.

The nonvolatile memory 120 stores therein a two-dimensional control parameter for each scene such as an environment or circumstances in a room as a scene setting parameter in addition to the two-dimensional control parameter set as the favorite in this manner by the user. As such a scene setting parameter, the two-dimensional control parameter for each scene of “Vivid”, “Studying”, “Sleeping”, “Relaxing”, “Theater”, “Healing”, or the like is stored in the nonvolatile memory 120.

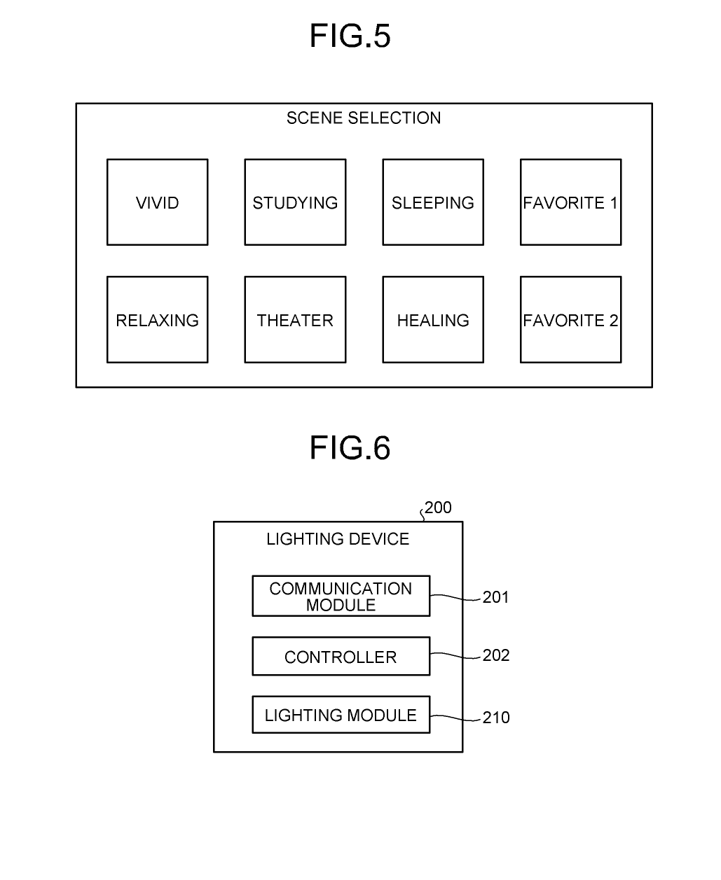

The input display controller 151 displays a scene selection window on the display device 102a when starting the lighting control application program or when starting to set parameters by a user. As illustrated in FIG. 5, the scene selection window displays therein buttons for invoking control parameters of the respective scenes set in the nonvolatile memory 120 and buttons for invoking favorite control parameters registered by the user.

When the user touches the button of the desired scene or the favorite, the input display controller 151 accepts the event of touching the button, the management controller 154 reads out the two-dimensional control parameter of the scene or the favorite corresponding to the button touched from the scene setting parameter in the nonvolatile memory 120, and the communication module 155 transmits the two-dimensional control parameter of the scene or the favorite that is read out to the lighting device 200.

Next, the lighting device 200 is explained. The lighting device 200 in the present embodiment mainly comprises a communication module 201, a controller 202, and a lighting module 210 as a functional constitution as illustrated in FIG. 6.

The lighting module 210 is a lamp such as an LED bulb unit using a red LED, a green LED, and a blue LED. The communication module 201 receives a control command from the electronic device 100. The controller 202 acquires a two-dimensional control parameter from the control command received in the communication module 201 and performs the lighting control of the lighting module 210 based on the two-dimensional control parameter. To be more specific, the controller 202 controls the lighting module to change a color tone, brightness, and an RGB value based on a color tone parameter, a brightness parameter, and an RGB parameter that are comprised in the control command.

Here, in the present embodiment, the lighting device 200 uses an LED bulb in the lighting module 210. However, the LED bulb is merely one example and the present embodiment is not limited to this example.

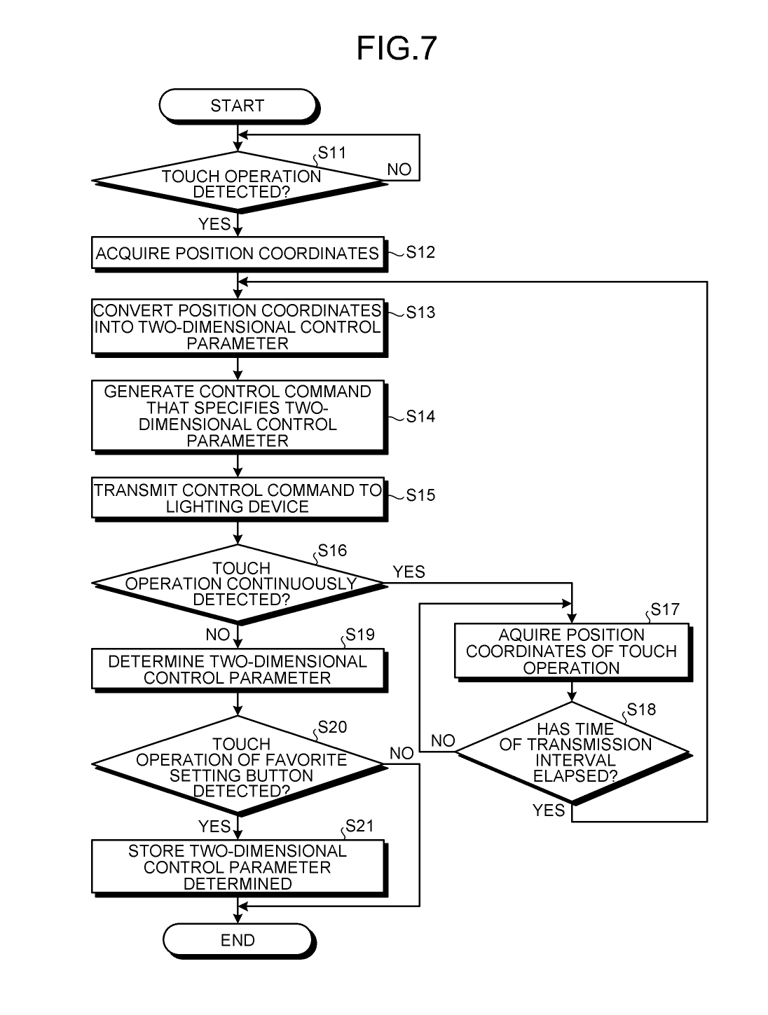

Next, lighting control processing in the electronic device 100 constituted as above in the present embodiment is explained in conjunction with FIG. 7.

The input display controller 151 is in a state of being waiting for detecting a touch operation from the touch panel 102b (No at S11). The input display controller 151 acquires, when the touch operation is detected (Yes at S11), the position coordinates of the touch operation from the touch panel controller 119 (S12).

Furthermore, the converter 152 converts, in reference to a conversion table in the nonvolatile memory 120, the position coordinates acquired by the input display controller 151 into a two-dimensional control parameter (S13). Next, the command generator 153 generates a control command that specifies the two-dimensional control parameter (S14). Furthermore, the communication module 155 transmits the control command generated in the command generator 153 to the lighting device 200 (S15).

Next, the input display controller 151 determines whether the touch operation is continuously detected (S16). When the touch operation is continuously detected (Yes at S16), the input display controller 151 acquires the position coordinates periodically acquired when the touch operation is continuously performed from the touch panel controller 119 (S17). Furthermore, the communication module 155 determines whether the time of a transmission interval has elapsed from the time of previously transmitting the control command (S18). When the time of the transmission interval has not elapsed (No at S18), the processing advances to S17.

On the other hand, when the time of the transmission interval has elapsed (Yes at S18), the processing from S13 to S15 is repeated. That is, the converter 152 converts the position coordinates acquired at S16 into a two-dimensional control parameter (S13), the command generator 153 generates a control command comprising the two-dimensional control parameter (S14), and the communication module 155 transmits the control command to the lighting device 200 (S15).

Owing to such a constitution, when a touch operation is continuously performed, the control command is transmitted to the lighting device 200 for each time of the transmission interval, the control command specifying the two-dimensional control parameter corresponding to the position coordinates of the touch operation at the time of the transmission interval. Accordingly, in the lighting device 200, when a user touches and drags with a finger or a stylus pen on a setting area, a color tone, brightness, an RGB value, or the like is continuously changed in response to the change of a touch position.

When a touch operation is not continuously detected (No at S16), the converter 152 determines a two-dimensional control parameter at present (S19). The input display controller 151 determines whether the touch operation of the favorite setting button 306 by a user is detected (S20). When the touch operation of the favorite setting button 306 is detected (Yes at S20), the management controller 154 stores the two-dimensional control parameter determined at S19 as a favorite of the scene setting parameter in the nonvolatile memory 120 (S21). On the other hand, when the touch operation of the favorite setting button 306 has not been detected (No at S20), the processing of S21 is not performed.

In this manner, in the present embodiment, in a case where a two-dimensional control parameter corresponding to a position coordinates of a touch operation in the setting area of the two-dimensional control parameter is set to control the lighting device 200, when a user continuously performs the touch operation, for each time of a transmission interval the communication module 155 transmits a control command that specifies the two-dimensional control parameter corresponding to the position coordinates at the time of the touch operation. Accordingly, in the present embodiment, a desired adjustment can be performed with respect to the lighting device 200 in a shorter time.

That is, in controlling lighting using a usual remote controller, a user maintains a state of touching a button on the remote controller thus changing the dimming of a lighting device to desired brightness or changing the toning of the lighting device to a desired color tone. However, in such a technique, when the user maintains a state of touching a button on the remote controller, the difference of periodically changing the color tone parameter or the brightness parameter is always constant and hence, it takes time until the lighting device reaches the desired color tone or brightness.

In contrast, in the present embodiment, when a user continuously performs a touch operation, the communication module 155 transmits a control command that specifies the two-dimensional control parameter corresponding to the position coordinates at the time of the touch operation for each transmission interval. Hence, when the user continuously performs the touch operation and quickly moves (drags with) a finger, a stylus pen, or the like, the speed of changing the two-dimensional control parameter corresponding to the position coordinates of a touch point increases. As a result, a color tone, brightness, or an RGB value of lights emitted from the lighting device 200 can be changed depending on a desired dragging speed of the user. Therefore, according to the present embodiment, a desired adjustment can be performed with respect to the lighting device 200 in a shorter time.

Furthermore, in the present embodiment, the transmission interval of the control command when the touch operation is continuously performed is determined based on the fade parameter of the lighting device 200. According to the present embodiment, it is possible to show the lighting device 200 to a user in such a manner that the color tone, the brightness, and the like of lights emitted from the lighting device 200 are continuously changed.

In addition, in the present embodiment, the two-dimensional control parameter determined by the management controller 154 is stored as a favorite thus easily reproducing the color tone, the brightness, the RGB value, and the like that are favorable to a user with respect to the lighting device 200.

(Modification)

The input display controller 151, the management controller 154, or the like may be configured to display, in a setting window of a two-dimensional control parameter, a color display indicated by the determined two-dimensional control parameter previously set in the lighting device 200 and a color display indicated by a two-dimensional control parameter corresponding to position coordinates at which a user currently touches in the setting area of the two-dimensional control parameter so that these color displays are displayed in parallel with each other in the setting area of the two-dimensional control parameter.

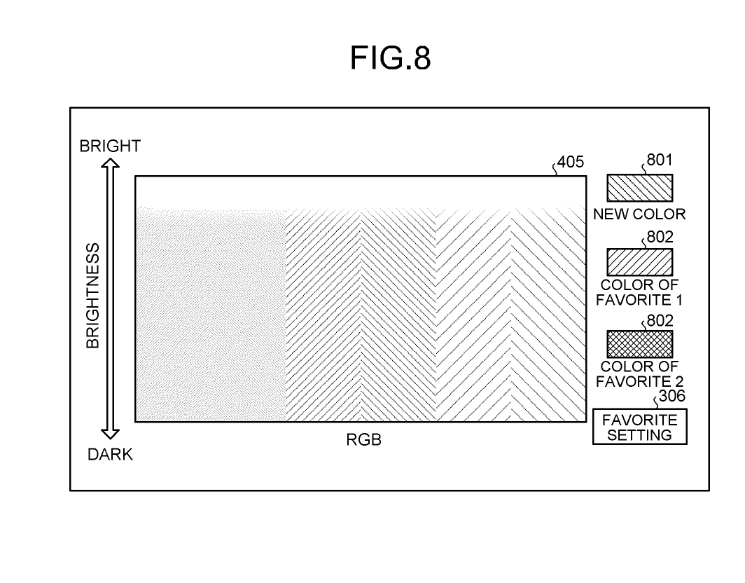

For example, to be more specific, in the setting window in setting an RGB parameter and a brightness parameter, the management controller 154 reads out the determined RGB parameter and brightness parameter such as a favorite from a scene setting parameter stored in the nonvolatile memory 120. Furthermore, the input display controller 151 displays, as illustrated in FIG. 8, colors corresponding to the RGB parameter and the brightness parameter thus read out as color displays 802 of “Color of Favorite 1” and “Color of Favorite 2” in the setting window.

The input display controller 151 displays, as illustrated in FIG. 8, a color corresponding to the RGB parameter/brightness parameter converted from the position coordinates of a current touch position by the converter 152 as a color display 801 of “New Color” in the setting window. When the touch position is moved so as to be dragged, the color display 801 of “New Color” changes along with the movement of the touch position.

In this manner, the input display controller 151 displays the color display by the two-dimensional control parameter previously set and the color display by the two-dimensional control parameter corresponding to the position coordinates of the current touch position in parallel with each other thus easily determining the change of the two-dimensional control parameter to be set by a user.

The input display controller 151 may be configured to display a cursor on the position coordinates corresponding to a value of the control parameter currently set in the lighting device 200 in the setting area of the two-dimensional control parameter illustrated in FIG. 3 or FIG. 4.

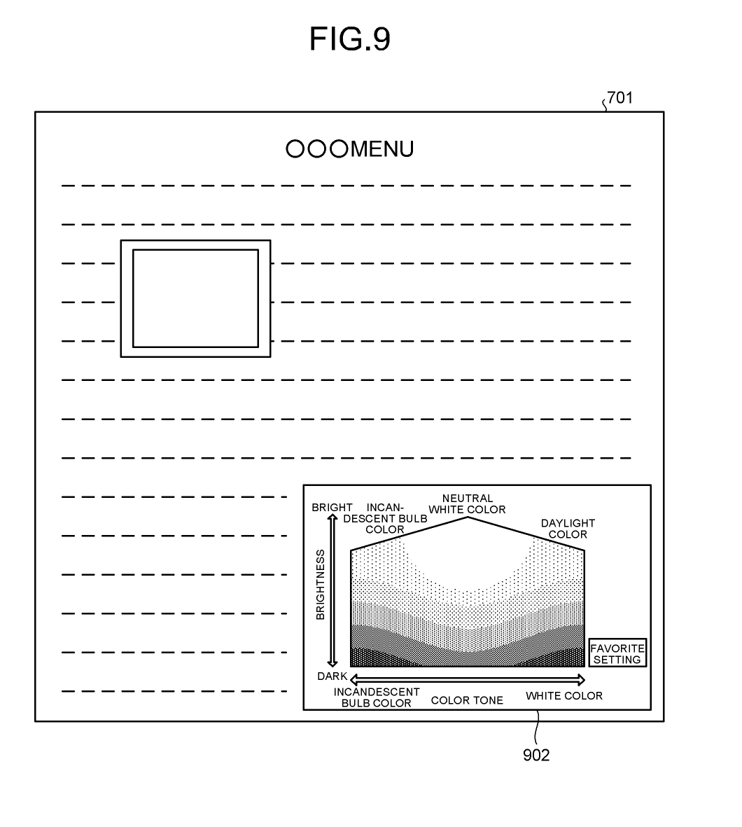

In the above-mentioned embodiment, although the setting window of the two-dimensional control parameter illustrated in FIG. 3 or FIG. 4 is displayed on the full screen of the display device 102a of the display module 102, the embodiment is not limited to above. For example, as illustrated in FIG. 9, the input display controller 151 may be configured to display a setting window 902 of a two-dimensional control parameter on a part of an entire screen 701 of the display device 102a.

In the above-mentioned embodiment, as one or a plurality of control parameters, two control parameters (two-dimensional control parameter) are used. However, the embodiment is not limited to above, and one control parameter may be used for lighting control. For example, when brightness is set constant, only one control parameter can be used out of the color tone parameter and the RGB parameter. In this manner, when one control parameter is used, the setting window illustrated in FIG. 3 or FIG. 4 may be, for example, configured such that the control parameter is specified by a user only on a one-dimensional axis out of an axis of abscissas or an axis of ordinate.

The above-mentioned embodiment has been explained by taking the electronic device 100 that controls one lighting device 200 as an example. However, the embodiment is not limited to this example, and the electronic device 100 may be configured to control a plurality of lighting devices 200. In this case, an individual control parameter may be set to each of the lighting devices 200 to separately perform the lighting control of each of the lighting devices 200. In addition, a control parameter common to the lighting devices 200 may be set to each of the lighting devices 200 to perform lighting control common to the lighting devices 200 by changing the common control parameter.

Here, the lighting control application program executed in the electronic device 100 of the present embodiment is provided as a computer program product in the form of the nonvolatile memory 120, a read only memory (ROM) (not illustrated in the drawings) or the like into which the program is integrated in advance.

The lighting control application program executed in the electronic device 100 of the present embodiment may be provided as a computer program product in the form of the storage medium capable of being read by the computer; that is, a CD-ROM, a flexible disk (FD), a CD-R, a digital versatile disk (DVD), or the like in which the program is stored in an installable or executable file.

In addition, the lighting control application program executed in the electronic device 100 of the present embodiment may be stored on the computer connected to a network such as the Internet and provided as a computer program product by downloading it via the network. The lighting control application program executed in the electronic device 100 of the present embodiment may be provided or distributed as a computer program product via a network such as the Internet.

The lighting control application program executed in the electronic device 100 of the present embodiment is constituted of modules comprising the above-mentioned respective modules (the input display controller 151, the converter 152, the command generator 153, the management controller 154, and the communication modules 155). As actual hardware, a central processing unit (CPU) reads out the lighting control application program from the above-mentioned ROM to execute the program, and thus the above-mentioned respective modules are loaded on the RAM 121, and the input display controller 151, the converter 152, the command generator 153, the management controller 154, and the communication modules 155 are generated on the RAM 121.

In addition, the various kinds of modules of the system described herein can be implemented as a software application, hardware and/or a software module, or a component on one or more computers such as a server. The various kinds of modules are separately explained. However, these modules may have some or all of same fundamental logics or codes in common.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input display controller configured to display a setting area for setting one or more control parameters with respect to lighting control of a lighting device on a display and to accept a touch operation on the setting area;
a converter configured to convert position coordinates of the touch operation on the setting area into the one or more control parameters corresponding to the position coordinates; and
a transmitter configured to transmit a control command indicative of the one or more control parameters to the lighting device and to transmit, when the touch operation is continuously performed for a first duration, a first control command indicative of one or more first control parameters corresponding to the position coordinates of the touch operation continuously performed for the first duration to the lighting device at a first transmission interval.

2. The electronic device of claim 1, wherein the first transmission interval is set based on a fade parameter indicative of a time required for changing at least one of the first control parameters of the lighting device by one step.

3. The electronic device of claim 2, wherein the first transmission interval is set to a longer time as the fade parameter becomes larger.

4. The electronic device of claim 1, wherein the converter is configured to determine, at a time when the touch operation continuously performed finishes, the one or more first control parameters converted from the position coordinates of the touch operation at the time when the touch operation continuously performed finishes, the electronic device further comprising:
a management controller configured to store the one or more first control parameters determined in storage.

5. The electronic device of claim 4, wherein the input display controller is configured to display a lighting display with respect to the one or more control parameters stored in the storage and a first lighting display with respect to the one or more first control parameters corresponding to the position coordinates of the touch operation currently performed in parallel with each other on the display.

6. The electronic device of claim 1, wherein the input display controller is configured to display the setting area in a partial area of the display.

7. A computer program product having a non-transitory computer readable medium including programmed instructions, wherein the instructions, when executed by a computer, cause the computer to perform:
displaying a setting area configured to set one or more control parameters with respect to lighting control of a lighting device on a display;
accepting a touch operation in the setting area;
converting position coordinates of the touch operation in the setting area into the one or more control parameters corresponding to the position coordinates; and
transmitting a control command indicative of at least one of the one or more control parameters to the lighting device, and transmitting, when the touch operation is continuously performed, a first control command indicative of at least one or more first control parameters corresponding to the position coordinates of the touch operation continuously performed to the lighting device at a first transmission interval.

8. A control system comprising:
an electronic device; and
a lighting device connected to the electronic device via a network, the electronic device comprising:
an input display controller configured to display a setting area for setting one or more control parameters with respect to lighting control of the lighting device on a display and to accept a touch operation in the setting area;
a converter configured to convert position coordinates of the touch operation on the setting area into the one or more control parameters corresponding to the position coordinates; and
a transmitter configured to transmit a control command indicative of the one or more control parameters to the lighting device, and to transmit, when the touch operation is continuously performed, a first control command indicative of at least one or more first control parameters corresponding to the position coordinates of the touch operation continuously performed to the lighting device at a first transmission interval, the lighting device comprising:
a lighting;
a receiver configured to receive the control command from the electronic device; and
a controller configured to perform lighting control of the lighting based on the one or more control parameters represented by the received control command.
